(19) United States
(12) Patent Application Publication
(10) Pub. No.: US 2013/0201552 A1
(43) Pub. Date: Aug. 8, 2013

(54) SPECIAL-ILLUMINATION SURGICAL STEREOMICROSCOPE

(71) Applicant: LEICA MICROSYSTEMS (SCHWEIZ) AG, Heerbrugg (CH)

(72) Inventor: Ulrich Sander, Rebstein (CH)

(73) Assignee: LEICA MICROSYSTEMS (SCHWEIZ) AG, Heerbrugg (CH)

(21) Appl. No.: 13/751,178

(22) Filed: Jan. 28, 2013

(30) Foreign Application Priority Data
Feb. 1, 2012 (DE) 10 2012 001 854.1

(51) Int. Cl. G02B 21/00; G02B 21/06

(52) U.S. Cl. CPC G02B 21/0076; G02B 21/06
USPC 359/385

(57) ABSTRACT

The present invention relates to a special-illumination surgical stereomicroscope (1) for observing an object (6) in an object field (15) under special illumination, the special-illumination surgical stereomicroscope including a surgical illumination light source (7; 7a) for illuminating the object field (15) via an illumination beam path (11) and further including a special-illumination light source. The special-illumination light source is adapted for observation of stimulated emission and includes an excitation light source (8a) for specific excitation of a substance contained in the tissue of the object (6) via an excitation beam path (12a), and a stimulation light source (8b) for stimulating the emission of light from the previously excited substance via a stimulation beam path (12b). A common observation beam path (14) is provided for guiding the light generated by stimulated emission and the reflected surgical illumination light.

### CROSS REFERENCE TO RELATED APPLICATIONS

This application claims priority of German patent application number 10 2012 001 854.1 filed Feb. 1, 2012, the entire disclosure of which is incorporated by reference herein.

### FIELD OF THE INVENTION

The present invention relates to a special-illumination surgical stereomicroscope, which term includes a conventional surgical stereomicroscope, a video surgical microscope, an endoscope, or a pair of surgical loupes, and to a method for operating such a special-illumination surgical stereomicroscope.

### DEFINITIONS OF TERMS

The definitions of certain important terms and functions are explained below.

A white light surgical microscope illumination device is known to those skilled in the art because it is used in a wide variety of surgical microscopes. It covers the entire spectrum of white light, since it is used principally to illuminate the surgical field and is generally intended to do so during surgery in as color-neutral a manner as possible. Of course, the object falling under the term “illumination device” includes a single light source, but is not limited thereto, and may also include several light sources. The white light surgical microscope illumination device may also include additional objects such as light-guiding components, protective filters (e.g., IR or UV filters or the like). In the present invention, the particular white light illumination device used is, in principle, not essential to the main idea of the invention. For example, the invention may also function with normal operating-room illumination, and in extreme cases even with daylight. Therefore, it is not mandatory for the present invention, but it can generally be assumed that the special-illumination surgical stereomicroscope includes a separate white light surgical microscope illumination device. Such an illumination device will, however, generally be present so that normal operations (not supported by special illumination) can also be carried out. What ultimately matters for the invention is the fact that illuminating light is delivered from any point onto a surgical field so that the latter may be illuminated and viewed by the user in as color-neutral a manner as possible.

In the context of a surgical microscope, a special light wavelength region is understood to be a light wavelength region that produces special observation effects on an object in the object field. In accordance with the prior art, such observation effects may be, in particular, fluorescence, autofluorescence, and false-color illumination, etc. Also, the special illumination does not necessarily have to come from the aforesaid white light surgical microscope illumination device, but may also be provided in known manner by a further light source or illumination device in accordance with the prior art.

In this application, the term “radiate” encompasses both “reflect” and “emit”, the latter in the case of fluorescence or stimulated emission. Based on the “Lexikon der Optik” [Encyclopedia of Optics], Spektrum Akademischer Verlag Heidelberg, Berlin, ISBN 3-8274-0382-0, 1999, pp. 188-189, a strict distinction is made in the following between spontaneous emission (fluorescence) and induced (stimulated) emission, which is clearly not a fluorescence phenomenon, although it appears so to the observer when viewed superficially.

Accordingly, the term “fluorescence” is used to refer to the spontaneous emission of light during the transition of an electron from an excited state to a lower energy state. The electron is previously lifted from the ground state to a higher energy state by irradiation with a specific wavelength, from where it goes to an intermediate state by vibrational relaxation. Through spontaneous emission of light; i.e., without outside influence, the electron changes to a lower energy state, from where it goes to the ground state, again through vibrational relaxation (see FIG. 1). The light emitted in the process is perceived as fluorescent radiation.

In the prior art, the light of the special-illumination device is in a spectral region that is controllable during operation by means of at least one selectably introducible working filter (e.g. illumination filter or excitation filter for exciting fluorescence or spontaneous emission).

As expressed by the broader generic term “special-illumination surgical stereomicroscope”, such surgical microscopes must be equipped both with equipment for surgery and with equipment for special-illumination microscopy (e.g. fluorescence microscopy, in the case of the fluorescence technique), and also for stereomicroscopy to enable them to be used for the purposes of special-illumination surgical stereomicroscopy.

The reflected portion of the surgical illumination light passes along the observation beam path and into the eyepieces or into a video camera, or onto video chips, one each per partial beam path, in order to be captured, electronically converted, and displayed on one or more monitors or displays.

Thus, a surgical stereomicroscope allows the observer to view the object field in three dimensions, and thus to recognize three-dimensional structures. Surgical stereomicroscopes generally have relatively low magnification.

A video surgical stereomicroscope additionally has a stereo video camera, or a video chip for each beam path, arranged in an image plane by way of beam splitters for photoelectronic conversion of a virtual image of the surgical field. Optionally, these stereo video cameras or video chips may be provided as an alternative to the eyepieces or eyepiece beam paths to present information to the surgeon solely via monitors.

The term “monitor” as used in the context of the present invention includes also devices for reflecting an image into a visual observation beam path of, for example, a surgical microscope or a head-up display.

Moreover, in addition to an additional (special) illumination device, a conventional special-illumination surgical stereomicroscope includes also filter devices which allow the surgeon to recognize, via optical or physical effects, more details or more physical or biological details of the object in the object field. One example is surgical fluorescence stereomicroscopy, which allows tumor tissues to be distinguished from healthy tissues by means of fluorescence excitation and observation.

### CLOSEST PRIOR ART

Surgical fluorescence microscopy is known from the prior art. In this technique, substances which are foreign to the body and which are present in human or animal tissue after having been introduced into the bloodstream or tissue are excited to fluoresce by excitation light. The fluorescent radiation produced is observed by the surgeon directly via observation filters.

A surgical fluorescence stereomicroscope is a microscope which is suitable for observing fluorescence phenomena and, for this purpose, is provided in particular with an excitation light source having an excitation filter and an observation filter in the observation beam path. Of the broadband light of the excitation source, only light which excites fluorescence in the object field is to pass through the excitation filter and reach the object field. The observation filter then in turn blocks the excitation light and allows only the light of the fluorescence phenomenon to pass (see U.S. Pat. No. 6,510,338 A). Frequently, the white light surgical illumination device; i.e., the white light source thereof, is used as the excitation light source.

German Patent Publication DE 195 48 913 A1 provides similar information on fluorescence observation or photodynamic diagnosis (PDD) using white light having at least a wavelength region from 370 to 780 nm. DE 195 48 913 A1 discloses an excitation filter in the illumination beam path and an observation filter in the observation beam path for visualizing the fluorescence spectrum.

European Patent Publication EP 1 691 229 A1 discloses, in the context of a stereomicroscope, an illumination device composed of two different illumination devices which are to be used together to intensify each other's light. However, since both illumination devices are to be used together for amplification during fluorescence excitation illumination, it is logical that the spectral region of light that both illumination devices must fundamentally and necessarily have in common is the fluorescence excitation region. In accordance with EP-A1-1 691 229, the widths of the two spectral regions should be different as long as they still have at least the fluorescence excitation region in common. For red light fluorescence, the second illumination device is optimized to emit red to infrared light. In contrast, for blue light fluorescence, the second illumination device will rather be optimized in the blue to ultraviolet region of the light spectrum, while the first surgical illumination device is optimized for white light in both cases.

Thus, for analysis and visualization of tumor tissue, for example, in the brain, special-illumination devices, and possibly filters or filter combinations, are used together with the surgical microscope for better visualization during brain surgery. In conventional surgical fluorescence microscopy, fluorescent drugs (e.g., 5-ALA (aminolevulinic acid)) are used, which may potentially harm the patient and have to undergo lengthy approval procedures.

In is an object of the present invention to avoid the use of such drugs.

This subject is addressed by a number of publications, including DE 10 2007 034 936 A1, DE 19 721 454 A1, EP 2 074 933 A1 and US 4786154A.

Also based on fluorescence is the disclosure of WO 87/04804 A1, whereby the visibility of fluorescent substances is increased using a filter wheel.

U.S. Pat. No. 3,798,435 A discloses a microscope which is provided with four light sources to be able to operate in different modes, including, inter alia, a mode based on the fluorescence principle, a transmitted-light mode and/or an incident-light mode.

German Patent Publication DE 101 23 785 A1 discloses a microscope having two light sources for illuminating the object field.

The use of filters to separate the excitation light from the emission light in surgical fluorescence microscopy negatively affects the efficiency of the white light from the surgical illumination device. The emission light is generally very weak and, in contrast to the visible white light (and, for example, also to the ambient light), is very hard to see. Therefore, great effort is required of microscope manufacturers in terms of illumination and filter technology.

In surgical microscopy, a data overlay device is often additionally used, for example, to overlay false-color images, outlines, or the like. This increases equipment complexity on the one hand, and on the other hand may additionally reduce the illumination efficiency with respect to the visible light from the surgical field.

Not every dye, chromophore, is fluorescent. Among the non-fluorescent dyes are in particular also endogenous dyes, such as, for example, hemoglobin or cytochromes.

The above description is simplified because the physical principle of spontaneous emission is known to those skilled in the art.

Stimulated emission, the physical fundamentals of which were developed at the beginning of the 20^{th} century, must be clearly distinguished from the phenomenon of fluorescence. In dyes which are not fluorescent, the return from the excited intermediate state to a lower energy state occurs by radiationless transition; i.e., without emission of a photon. In order to nevertheless cause such dyes to emit radiation or light, the principle of stimulated emission is used in other technical fields. Specifically, it is possible to excite the electron during its transition from the excited to the ground state, without emission of photons. In the process, the excited atom or molecule is already in the field of an intensive light source (stimulation light). Stimulated emission occurs when there is resonance. As for the mechanism of action, reference is made to the “Lexikon der Optik” [Encyclopedia of Optics], Spektrum Akademischer Verlag Heidelberg, Berlin, ISBN 3-8274-0382-0, 1999, pp. 188-189, and to “Technische Optik” [Technical Optics], Schroder, Gottfried, WÜrzburg, ISBN 3-8023-0067-X, 1984, section 4.3.5. There, stimulated emission is described as the basis of the laser effect. The more intensive the second, stimulating laser beam, the greater the probability of occurrence of such stimulated emission (see “Spektrum der Wissenschaft” [Spectrum of Science], April 2010, “Erzwungenes Leuchten” [Forced Emission of Light] by Stefan A. Maier). This article erroneously speaks of fluorescence a number of times, but, as already explained above, fluorescence is defined as spontaneous emission, and therefore has nothing to do with stimulated emission as postulated by Einstein. In any case, it is also important here that the stimulated emission occurs simultaneously with the stimulation. This means that incident stimulation light is reflected on the one hand, but on the other hand also radiated by emission from the object.

The article “Imaging Chromophores with Undetectable Fluorescence by Stimulated Emission Microscopy” by Wei Min et al. in “Nature”, Vol. 461, 22 Oct. 2009, describes that the principle of stimulated emission can be used to visualize cells that have been genetically manipulated.

Specifically, this scientific article discloses a transmission microscope with extreme magnification (allowing observation of objects down to 1 μm (micrometer)), in which an excitation beam and a stimulation beam are directed at the sample from below and passed therethrough. The excitation beam and the stimulation beam are spatially overlapped by input coupling optics and directed at the sample from below in order to pass therethrough. A photodiode disposed on the opposite side of the sample and having a downstream lock-in amplifier detects the stimulated emission of the chromoproteins gtCP and cjBlue, for example. In the experimental setup, a 200 fs (femtosecond) pulse train is used for excitation, and another 200 fs pulse train is used for stimulation. The delay between the two pulse trains is selected to be 300 fs. The excitation beam is modulated at 5 MHz so that the resulting signal, which is composed of the stimulation light and the stimulated emission light, is also modulated at 5 MHz with respect to the emission component. This makes it possible to separate the stimulated emission from the stimulating radiation during the analysis of the signal received at the detector. Corresponding demodulation is performed by the lock-in amplifier.

This technique must be clearly distinguished from Stimulated Emission Depletion (STED) microscopy. STED microscopy aims at increasing the resolution of very small objects (smaller than the wavelength of the light used for examination). In STED microscopy, the resolution is not limited by diffraction. STED microscopy can also only be performed with the aid of fluorescent dyes. The higher resolution is achieved because the light comes from a region of the sample that is smaller than the optical resolution. To do this, after fluorescence excitation, the excited spot is selectively de-excited by a second light beam. This second light beam has an intensity distribution which is zero at the center of the beam. Therefore, no stimulated emission occurs at this point, so that fluorescent radiation from the central region can be detected and used for generating an image. Thus, the light observed is fluorescent radiation; i.e., spontaneous emission. This technology is solely used in scanning microscopy (see WO 2005/024486 A1).

The contents of all cited publications are incorporated herein by reference.

In surgical microscopy, however, the technological requirements are completely different from those in the field of high-magnification scanning microscopy or transmission microscopy. Magnification is relatively low (about 4-40 fold); the recognition of tissue structures must always be accomplished without analysis and processing procedures and be capable of being performed directly by the surgeon. The light coming from the object must be viewable directly in real-time through the eyepieces. Additional, or sometimes alternative, transmission to a monitor is possible, but must also be performed in real-time and from the perspective of the surgeon's view; i.e., from the perspective during reflected light observation. The article mentioned and the scientific work do not provide any teaching or suggestion in this regard and, therefore, would not be considered by one skilled in the art for achieving the objects of the present invention.

The use of fluorescent contrast agents is associated with significant medical side effects. Nevertheless, the contrast often leaves a lot to be desired. With regard to the filter combinations used, compromises must be made (reduced efficiency of the illumination and excitation light). The large number of required filters and their controls make a microscope complicated to manufacture and difficult to use.

It is another object of the present invention to overcome these disadvantages as well, and to provide a special-illumination surgical stereomicroscope that is capable of achieving better contrast between tissue structures for the viewer and can be used for its intended purpose without having to administer fluorescent contrast agents to the patient, while increasing the ease of use of the surgical microscope itself.

### SUMMARY OF THE INVENTION

This object is achieved in accordance with the present invention by a special-illumination surgical stereomicroscope and a method according to the instant specification. In order to allow observation of stimulated emission of light from a substance contained in the tissue in an object field, the surgical stereomicroscope is configured to include at least the following devices:

a surgical illumination device having a white light source and an illumination beam path for conventional illumination of the object field,

an excitation illumination device having an excitation light source and an excitation beam path for specific excitation of a substance contained in the tissue of an object in the object field,

a stimulation illumination device having a stimulation light source and a stimulation beam path for stimulating the emission of light from the previously excited substance,

a conventional observation beam path along which the light generated by stimulated emission and/or the light resulting from the reflection of the white light surgical illumination is guided away from the object.

The inventive idea is based on the fact that in surgical microscopy, in particular in surgical stereomicroscopy, it is now possible to cause light emission also in endogenous tissue substances that do not exhibit visible fluorescence. In the present invention, the visualization of stimulated light emission is integrated with the conventional surgical microscopy technique, in which the object was heretofore visualized only by the reflection of white surgical illumination light or by fluorescence. In accordance with the present invention, no filters or drugs are needed, which avoids the disadvantages described above.

Excitation is accomplished using a completely different light source which is not known for use in surgical microscopes and which is cable of causing normally non-luminescent endogenous substances to emit visible light, such as, for example, hemoglobin (e.g., using 830 nm excitation light at 20 mW, for example, and a stimulation wavelength of 600 nm at 3 mW, for example). This is important, among other things, to distinguish well-perfused tumor tissue from healthy, more poorly perfused tissue. To this end, in accordance with the invention, stimulated emission is used in a novel way under the surgical microscope. This technique is clearly different from the fluorescence technique heretofore used under surgical fluorescence microscopes. Only the effect observed by the surgeon appears to be similar. However, if the light sources and the operating modes are suitably designed, the effect appears much better, especially when also taking into account the possibility of amplification by video image data processing.

In order to implement this principle, two additional light sources are needed, preferably two laser light sources, which are provided in addition to the existing white light surgical illumination device. These additional light sources must be capable of producing stimulated emission by time-staggered pulses from one (laser) light source and subsequently from the other laser light source. The excitation light source (one of the laser light sources) has a specific wavelength or a narrow band of wavelengths for selectively exciting the electrons of the substances sought. The wavelength used corresponds to the energy difference between the electron levels of the respective substances. The stimulation light source (second laser light source) serves to stimulate light emission from the intermediate state Z1 (FIG. 1), which is reached by vibrational relaxation from the first, excited state A. During stimulated emission, the electrons go from a state Z1 to a lower energy state, and from there to the initial ground state, again by vibrational relaxation. Thus, the wavelength, or narrow band of wavelengths, of the stimulation light source is smaller than the wavelength of the excitation light source (in each case in accordance with the energy difference caused by the vibrational relaxation).

The laser pulses may be coupled into the illumination beam path of the surgical illumination light source by input coupling optics, using either a physical or a geometric beam splitter. Optionally, in order to avoid interference with the illumination beam path or the observation beam path, the laser light may also be irradiated directly onto the object from the side of the microscope, thereby possibly increasing the efficiency of the laser light.

The space requirements of lasers are continuously reduced, so that, in one embodiment of the present invention, the lasers can also be fitted directly into the illumination devices used heretofore, which eliminates the need for a special input coupling device. This not only saves space, but reduces the number of additional assemblies outside of the microscope.

From the article “Microcavity Laser Oscillating in a Circuit Based Resonator”, by Christoph Walther et al., in “Science”, 19 Mar. 2010, Vol. 327. no. 5972, pp. 1495-1497, it is known that the dimensions of a microlaser may be even smaller than the wavelength of the generated light. A laser with a size of 30 μm was successfully manufactured. The contents of this publication are hereby incorporated herein by reference. The lasers described therein could be used for the purposes of the present invention.

In one embodiment of the present invention, a controller controls the laser light sources temporally in such a way that, through modulation of the pulse duration and spacing, an optimized stimulated emission can be observed. Thus, in this configuration of the present invention, there is no need to use expensive special spectral filters, which would attenuate the visible light.

The stimulated emission described in the prior art does not provide any teaching that could be used for surgical microscopes because it is directed only to magnifying microscopes for transmitted light which have extreme (about 1.000-fold) magnification, which generally do not operate stereoscopically, and which require complicated processing procedures. Moreover, in this prior art, the stimulated emission light cannot be observed directly by the user for design-related reasons. Also, it not possible to make images available in real-time. In addition, the known technique uses the principle of transmitted illumination, which is completely unsuitable for surgical microscopy. Therefore, one skilled in the art would not consider such microscopes and their illumination devices as a replacement for existing special-illumination surgical stereomicroscopes.

The present invention is directed to a surgical stereomicroscope, because in surgical microscopy, three-dimensional magnified visualization of the surgical site is of primary importance, and because the present invention allows it to be used now in an optimized way under the conditions of simulated emission.

Further embodiments of the present invention will become apparent from the figures, their descriptions, and the dependent claims.

The list of reference numerals, such as the technical content of the claims, is part of the disclosure.

### BRIEF DESCRIPTION OF THE DRAWING VIEWS

The present invention is schematically described in more detail by way of example and with reference to the figures.

The figures are described collectively. Identical reference numerals denote identical components; reference numerals having different indices indicate functionally identical or similar components.

In the drawing,

FIG. 1 shows an energy level diagram illustrating stimulated emission;

FIG. 2 shows a special-illumination surgical stereomicroscope according to the present invention;

FIG. 2a illustrates a configuration similar to that of FIG. 2, but including a scanner and a white laser as the surgical illumination light source;

FIG. 2b shows a configuration similar to that of FIG. 2a, but having an additional conventional surgical illumination light source 7;

FIG. 3 depicts a variant where the excitation light source and the stimulation light source are integrated with the surgical illumination light source into an illumination light source unit;

FIG. 3a illustrates a configuration similar to that of FIG. 3, but having an additional white light laser as a second surgical illumination light source;

FIG. 4 depicts a variant where the excitation light source and the stimulation light source are disposed on opposite sides of the surgical illumination light source;

FIG. 5 shows a variant where the excitation light source and the stimulation light source are arranged in the wall or an opening of a concave mirror;

FIG. 5a illustrates a configuration similar to that of FIG. 5, but including an additional white light laser source and laser beam expansion optics;

FIGS. 6, 7, and 8 illustrate the time sequence of the irradiation of illumination light, excitation light and stimulation light in different modes of operation; and

FIG. 9 depicts an alternative configuration having a video chip.

### DETAILED DESCRIPTION OF THE INVENTION

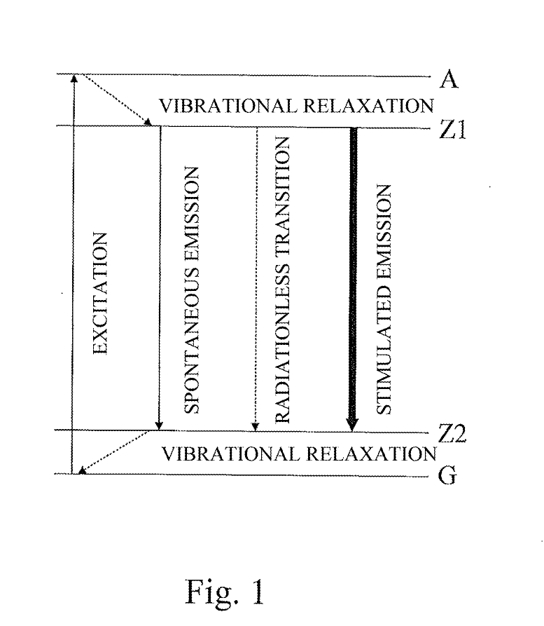

FIG. 1 shows an energy-level diagram illustrating the differences between stimulated emission, radiationless transition, and spontaneous emission (fluorescence). Radiation from an excitation light source causes an electron to go from ground state G to an excited state A. From there, the electron goes to an intermediate state Z1. In the case of non-fluorescent substances, this is followed by a radiationless transition to a lower energy state Z2, from where ground state G is reached again by vibrational relaxation.

Spontaneous emission (autofluorescence), which is also shown in FIG. 1, occurs only in fluorescent substances and without the need for separate excitation. However, since endogenous substances do not exhibit fluorescence, except for the rather low autofluorescence, and therefore foreign fluorescent substances are used, the present invention, in contrast, uses the principle of stimulated emission, which in many interesting endogenous substances in the body (e.g., hemoglobin) occurs in the visible range. As indicated in the diagram of FIG. 1, stimulated emission is significantly stronger and can therefore always be seen better and without using fluorescent dyes.

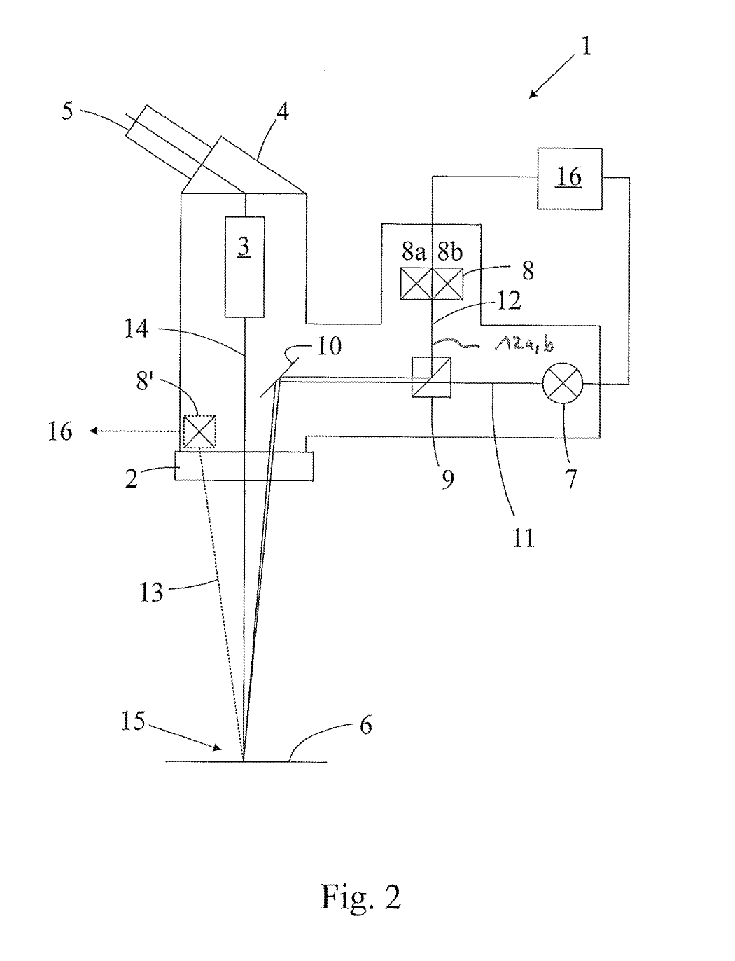

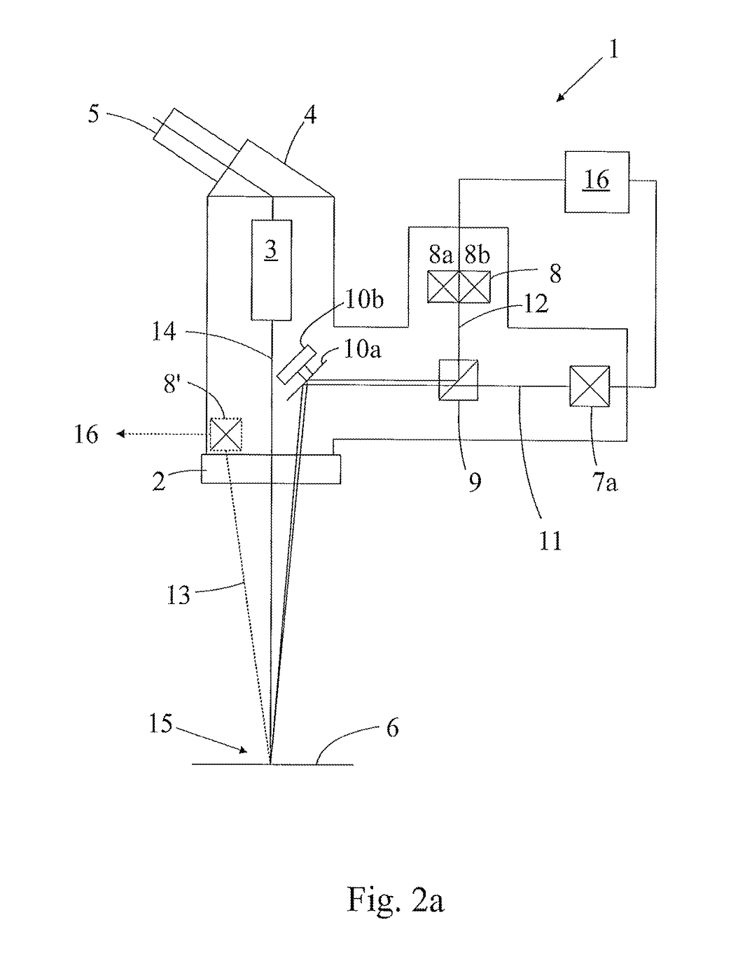

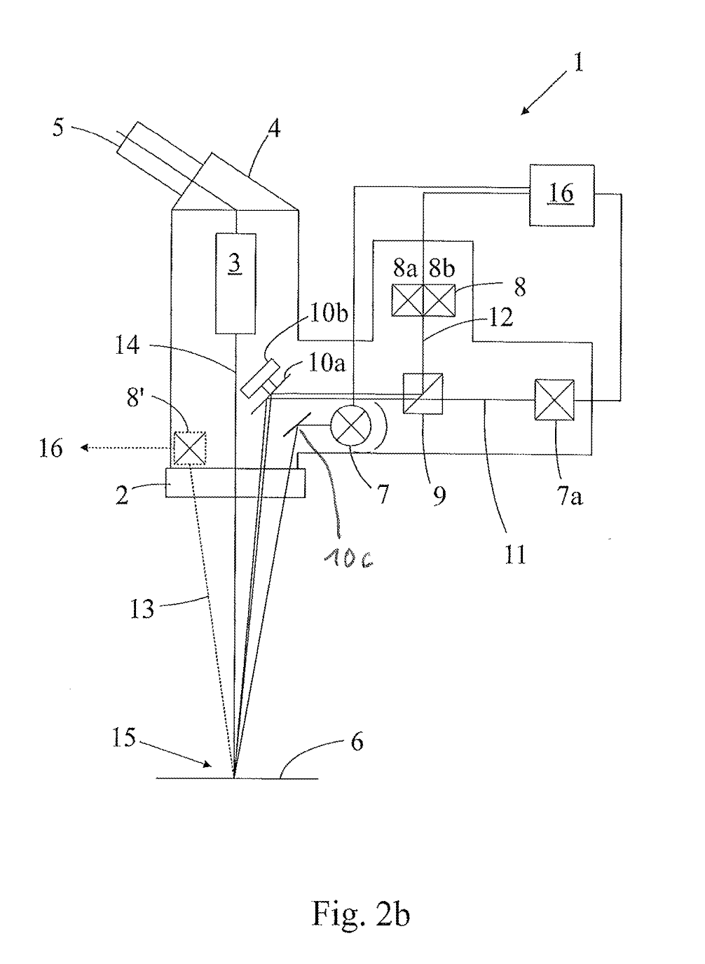

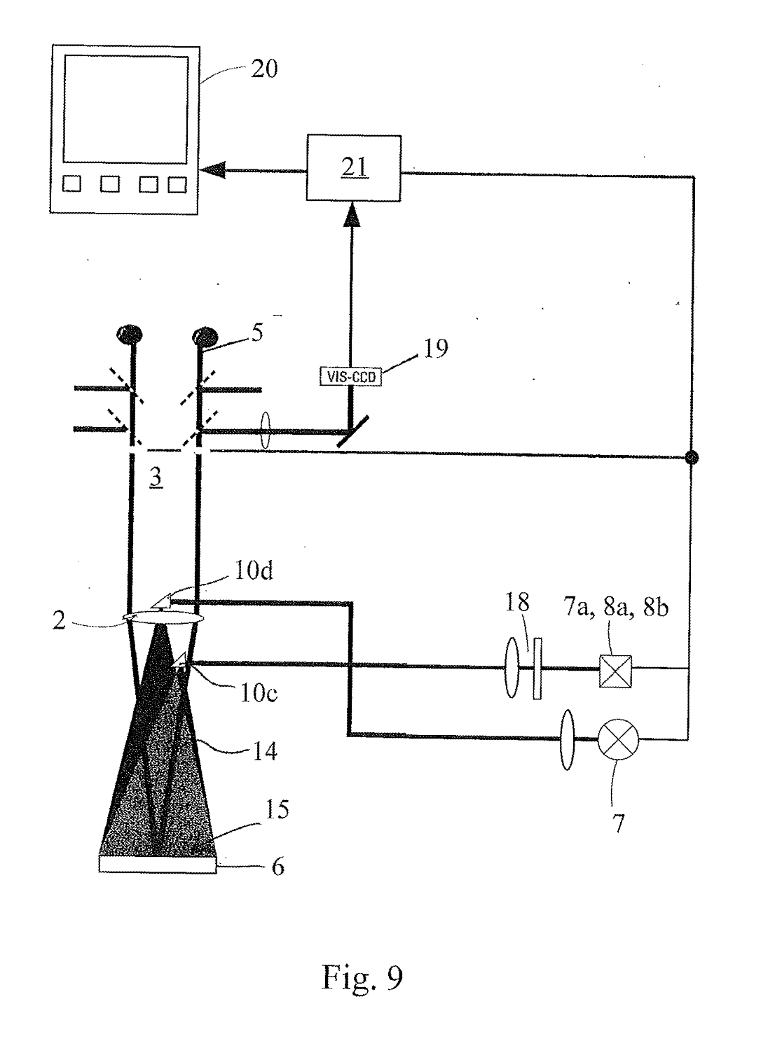

FIG. 2 shows a surgical microscope 1 according to the present invention. A surgical illumination light source 7 emits white light, or at least nearly white light, which is directed along illumination beam path 11 to illuminate an object field 15 having an object 6 located therewithin. Reference numeral 10 denotes a deflecting element, such as a mirror or prism (see 10d in FIG. 9), which directs the surgical illumination beam onto object 6. The light reflected from object 6 is directed along observation beam path 14 to the observer. This light passes through main objective 2, a zoom system 3, a tube 4, and eyepiece 5. Thus, by using white light, the surgeon is provided with the usual natural image of the object 6 in object field 15.

In accordance with the present invention, there is provided an additional excitation light source 8a and a stimulation light source 8b, whose radiation is coupled into illumination beam path 11 via the excitation/stimulation beam path 12 and through input coupling optics 9. Excitation light source 8a emits at a specific wavelength which corresponds to the energy difference between the ground state and the excited state in a particular substance (e.g., hemoglobin) (see FIG. 1, “excitation”). Instead of a discrete wavelength, it is also possible to use a narrow-band spectrum around this specific wavelength.

Stimulation light source 8b emits light which has a smaller wavelength than that of excitation light source 8a and which corresponds to the wavelength of the light that is subsequently emitted from the respective endogenous substance being observed, it (the stimulation wavelength) corresponding to the wavelength of the stimulated emission light and being capable of optimally triggering the same by de-excitation. Here, too, a narrow-band spectrum around a likewise substance-specific wavelength may be used in place of this discrete wavelength. However, the narrower the wavelength band of the stimulation light, the more specifically can a specific material having this emission characteristic be excited into stimulated emission.

Depending on which endogenous substances are intended to be excited into luminescence, different excitation and stimulation light sources are needed. For purposes of ascertainment, the individual energy-level diagram of a substance must be used, which then defines the wavelengths.

Lasers are preferred for use as the excitation light sources and stimulation light sources. Femtosecond lasers are perfectly suited for this purpose because they can excite and trigger alternatively with a short pulse duration and high repetition rates. The wavelengths required depend on the tissue substance to be examined, but the stimulated emission occurs preferably in the visible range. However, approaches using stimulated emission and suitable visual aids (e.g., sensor/monitor systems) are thereby not excluded from the present invention.

The surgeon does not have to adapt to changes from conventional fluorescence-assisted surgery. It is only that the visibility is improved and the effort previously required to select from a wide variety of filters is eliminated.

The surgical microscope of the present invention does not need any illumination filters or observation filters because the specific excitation and the stimulation are accomplished using wavelength-specific or very narrow-band laser light sources.

In the exemplary embodiment of FIG. 2, excitation light source 8a and stimulation light source 8b are integrated into an excitation/stimulation device 8, which is preferably replaceably mounted as a single unit in surgical microscope 1 to provide specific wavelengths for a particular substance.

Alternatively, excitation/stimulation device 8′ may irradiate object 6 directly from the side of the microscope. The corresponding variant is illustrated in dashed lines in FIG. 2.

The light generated by stimulated emission, such as the illuminating light reflected from the object, is delivered to the observer via observation beam path 14. Generally, however, this will occur successively in time; i.e., the surgeon decides whether he or she wants to see the object field under white light surgical illumination or in the stimulated emission mode. Combined illumination is, of course, also possible. In order to provide a particular background illumination of the object field, white light may be irradiated with reduced intensity by means of neutral density filters. By using different kinds of color filters, it is also possible to provide background illumination in a spectrally selective manner. In this connection, reference is made to the not previously published German Patent Application DE 10 2010 044 503 of the Applicant. The contents of this application are hereby incorporated herein by reference for combination with the teachings of the present application and are thereby disclosed.

An electronic control and data processing unit 16 is connected to excitation light source 8a, stimulation light source 8b, and surgical illumination light source 7 and controls the time sequence of the individual light pulses; i.e., the operation of the individual light sources. Control and data processing unit 16 may also be connected to excitation/stimulation device 8′ and surgical illumination light source 7. The operating principle of control and data processing unit 16 and the different modes of operation will be explained further below.

A variant of FIG. 2 is illustrated in FIG. 2a, where a white light laser source 7a is used in place of a conventional white light surgical illumination source. Optionally, this laser light source 7a may also be designed as a white light femtosecond laser, which may be clocked in such a way that it alternates with lasers 8a and 8b with respect to the light energy delivered to the object to thereby enable different viewing modes that are not possible under simultaneous illumination. This, particularly in combination with an also clocked video chip, enables the white light illumination and the excitation/stimulation illumination to be separated from each other.

The three lasers 7a, 8a and 8b direct light onto a scanning mirror 10a, which is controlled by a scanner motor 10b in such a way that it illuminates the object field point-by-point along a scanning trajectory. If the laser beams of the three lasers 7a, 8a, 8b are directed onto mirror 10a in spatially different ways, then the white light illumination, the excitation, and the stimulation occur successively in time, so that there is no local overloading of the tissue, and the reflection, excitation and stimulation; i.e., stimulated emission, occur at different times for each point of the object field. Although the observer will not be able to perceive these processes by the naked eye, a fast high-resolution video chip may utilize this temporal point-by-point illumination of the object to make completely different images available for display after suitable data processing, separately according to white light illumination, excitation state, and stimulated emission.

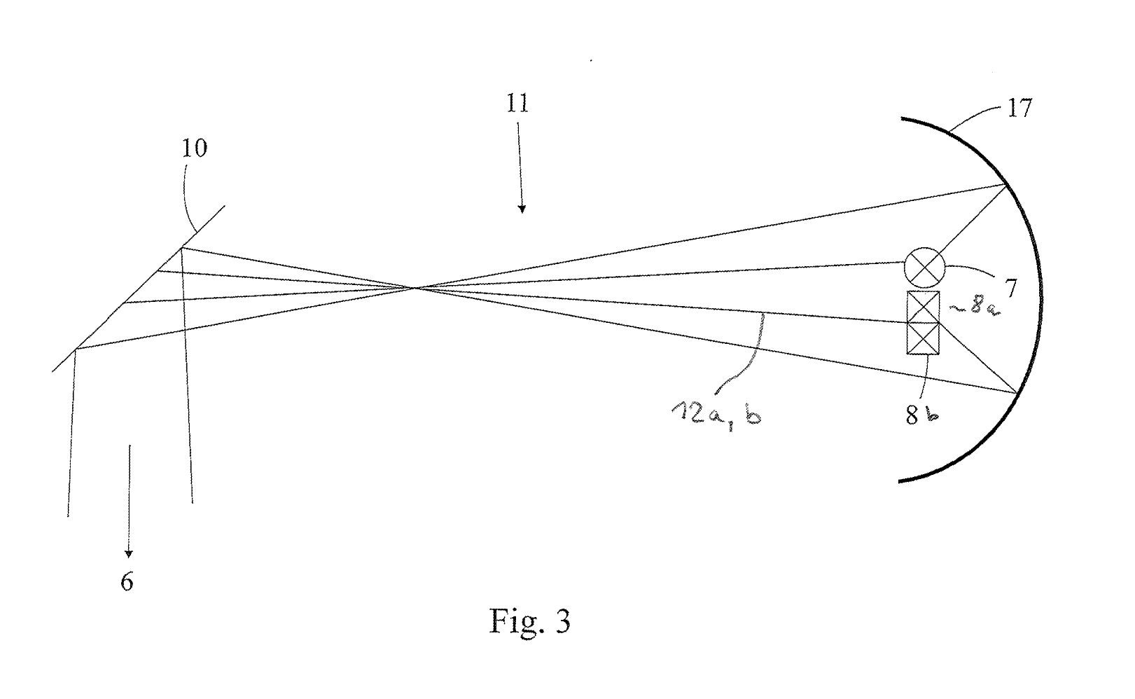

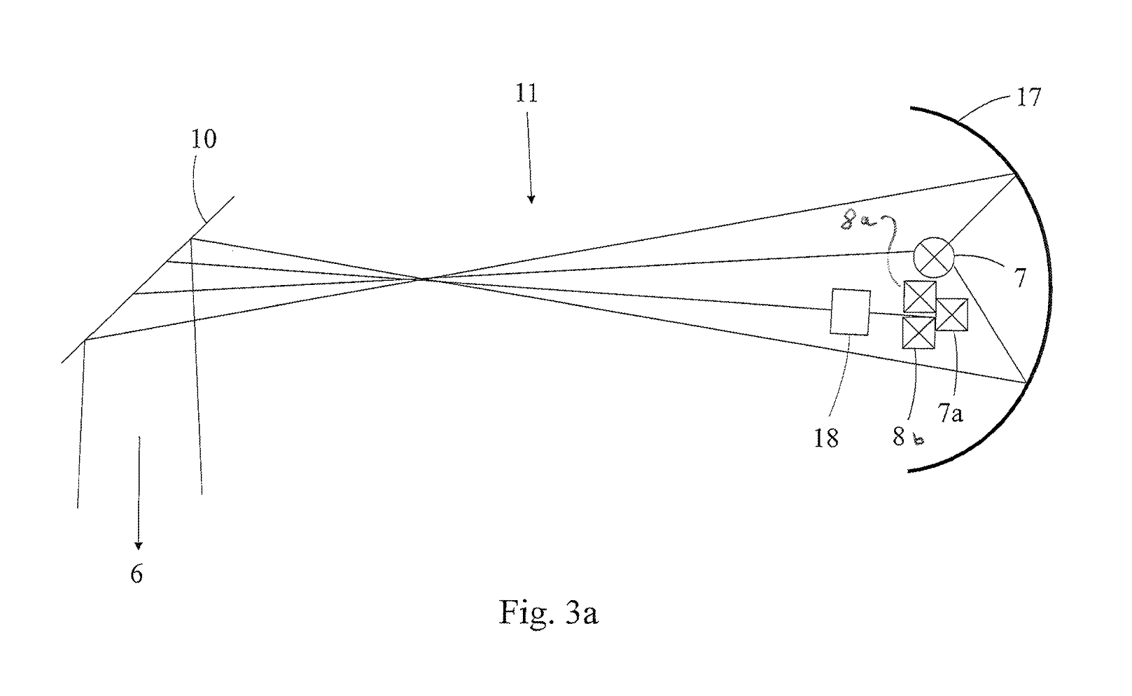

In the present invention, it is, of course, also possible to use a separate scanning device for each laser in place of a common scanning mirror 10a. Alternatively, it is also possible to dispense with the scanner and to use, for example, a beam expansion means (see 18, FIG. 3a). In this case, however, the lasers themselves will preferably be clocked in such a way that they illuminate the object at different times in order to cleanly separate the effects.

FIG. 2b shows a configuration similar to that of FIG. 2a, but with the difference that an additional (conventional) white light illumination source 7 is provided which is capable of illuminating object field 15 via a separate deflecting element 10c. This configuration allows the surgeon to use this surgical stereomicroscope as before. However, it is now additionally possible to obtain an amplification of the white light by using white light laser 7a and the other illumination and viewing modes indicated above.

By spectrally separating the light from white light laser 7a (e.g., using a prism), any desired wavelengths may be obtained and used to illuminate the object. Thus, if white light laser 7a is suitably designed, it can replace excitation laser 8a and stimulation laser 8b, so that it may perform all functions in a time-staggered manner, given suitable control of the spectral separation (i.e., of the prism).

FIG. 3 depicts a variant of surgical microscope 1 in a view which, for the sake of simplicity, shows only a portion (the right portion of FIG. 2). In the configuration shown in FIG. 3, excitation/stimulation device 8 is disposed in the immediate vicinity of surgical illumination light source 7. Here, all light sources 7, 8a, 8b are integrated into a common illumination light source unit. This results in a common beam path 11 from light sources 7, 8a, 8b to object 6.

Light sources 7, 8a, 8b are located in the focal region a concave mirror 17, which focuses the beams from the light sources toward object 6. Therefore, the emission from the excitation light source 8a and stimulation light source 8b does not have to be directional, although this will usually be the case, both generally and in particular with respect to the preferably selected laser light sources. Instead of a concave mirror 17, which may have a free-form surface in accordance with beam shape requirements, it is also possible to use other beam-shaping elements, such as, for example, additional lenses or mirrors.

FIG. 3a illustrates a configuration which is a variant is of that shown in FIG. 3 and includes an additional white light laser 7a which, similar to excitation/stimulation device 8, is disposed in the region of surgical illumination light source 7 and may be used to illuminate the object. All lasers 7a, 8a, 8b may have an integrated scanning device or a beam expansion device 18 in order to illuminate the entire object field 15 and object 6, respectively.

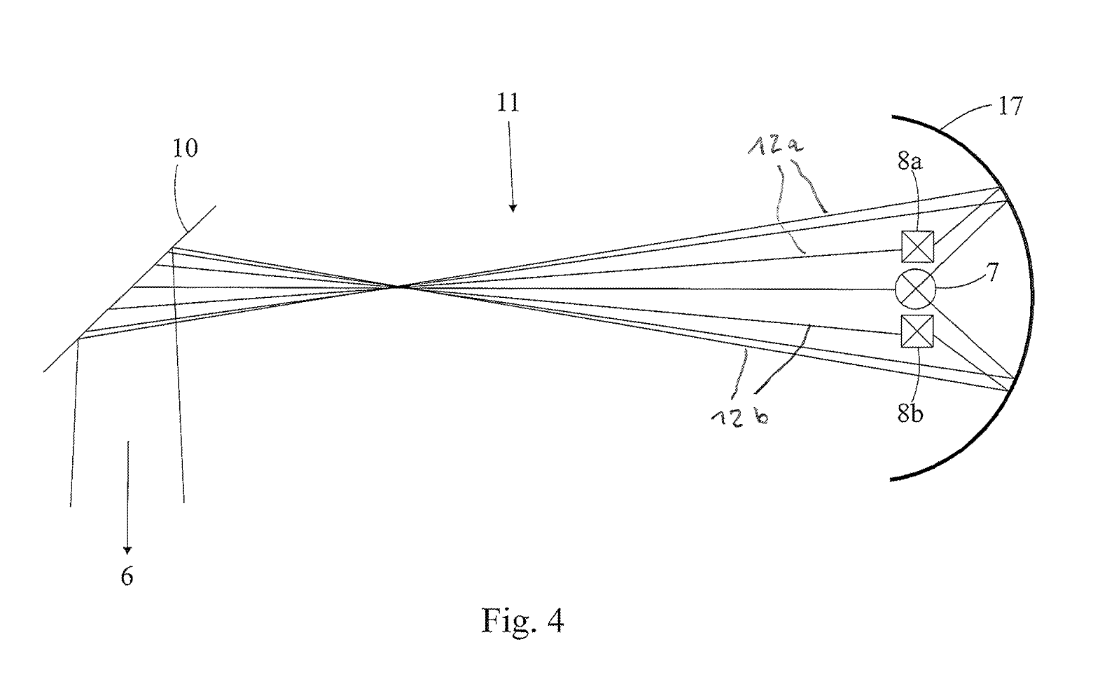

FIG. 4 shows a variant where excitation light source 8a and stimulation light source 8b are disposed on opposite sides of and spaced from surgical illumination light source 7. By this measure, all light sources 7, 8a, 8b may be arranged symmetrically with respect to the axis the focus of concave mirror 17. This ensures that the object field is illuminated as homogeneously as possible, regardless of which particular light source is selected. In addition, the major portion of the illumination quality; i.e., of the light distribution, is provided by the white light surgical illumination source in accordance with the demands generally placed on any surgical microscope by every surgeon.

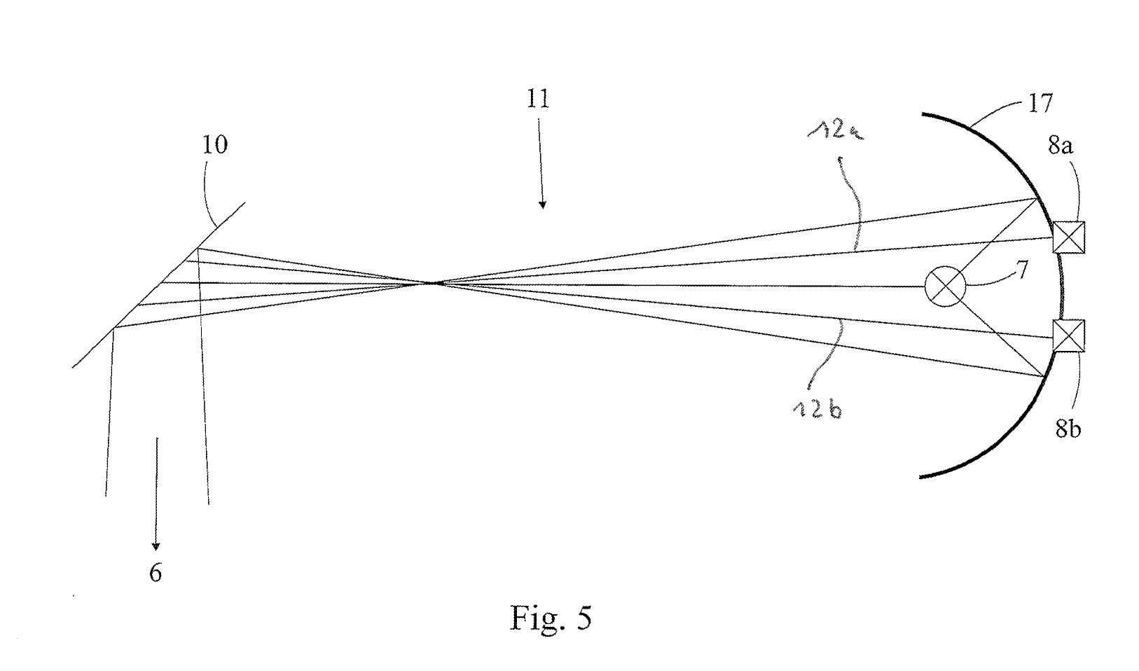

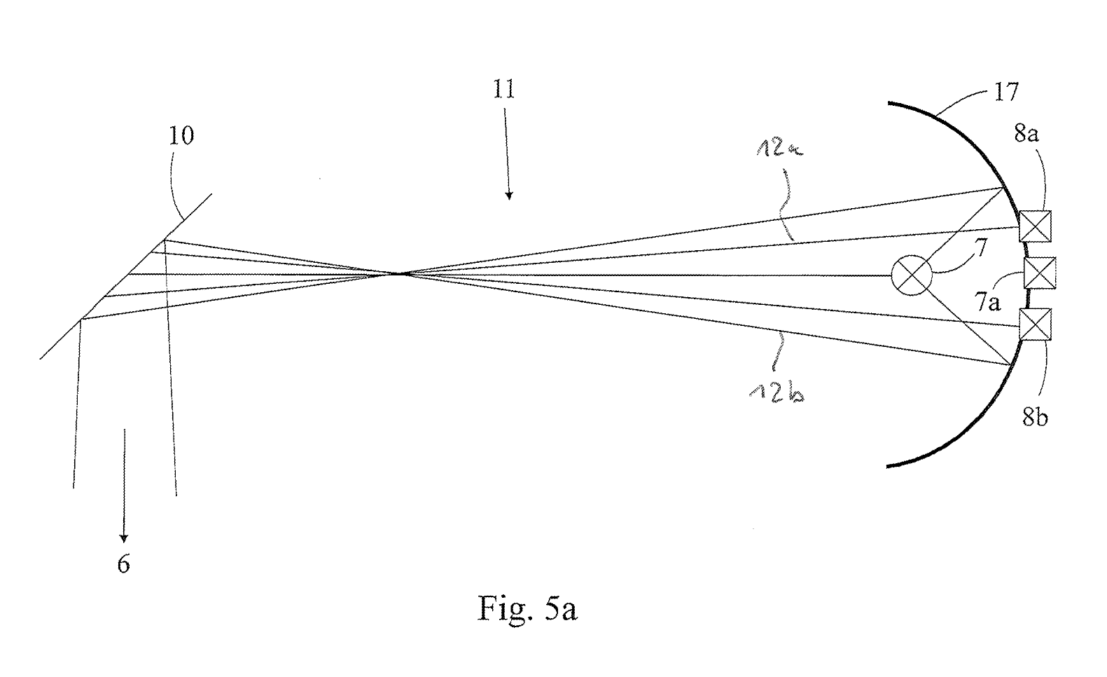

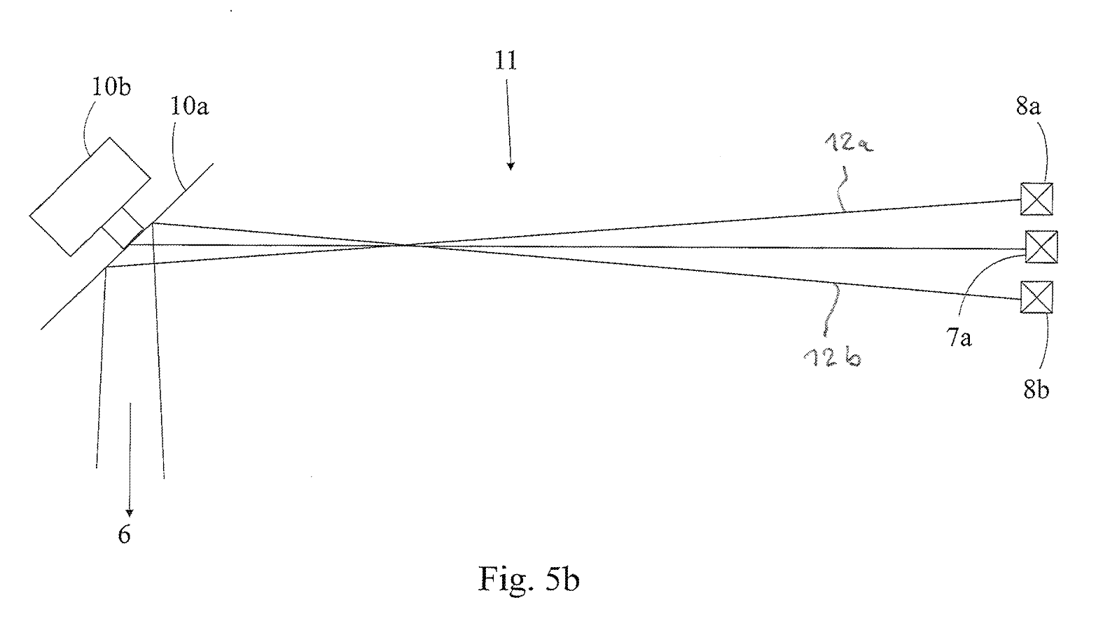

In another variant (FIG. 5), excitation light source 8a and stimulation light source 8b are disposed behind surgical illumination light source 7 in the wall; i.e., openings of concave mirror 17. The light sources used are preferably directional laser light sources. If necessary, the laser light sources may have suitable beam-shaping optics associated therewith which make beams of flat or oval shape as circular as possible to ensure uniform illumination of the object field with the laser light. Besides, in another embodiment of the present invention, it is advantageous to sweep the laser beams in a scanning mode across the surface to be illuminated, excited and/or stimulated. The laser beams are swept across the surface to be illuminated by means of upstream beam-deflecting elements and in such a way that the entire surface is illuminated point by point. This makes it possible to achieve particularly high energy densities for the excitation and stimulation, and to thereby produce particularly strong stimulated emission.

Optionally, the scanning operations may be performed one after another in temporal or spatial succession such that an excitation laser beam runs ahead of a stimulation beam along the same path. Using a suitable excitation wavelength and correspondingly high laser power, it is thus possible to excite maximum emission.

FIG. 5a shows the same configuration as FIG. 5, with the difference that here a white light laser 7a is additionally provided as a second surgical illumination light source which may be used alternatively or in addition to light source 7.

The configuration shown in FIG. 5b corresponds in principle to that of FIG. 5a, with the difference that the conventional illumination device 7 is omitted, and therefore the concave mirror can also be dispensed with. Here, a white light laser source 7a provides the complete surgical illumination with white light. Deflecting device 10a is here adapted for scanning illumination and is therefore also provided with a scanner motor 10b.

The laser light sources used are preferably small laser-diode-like laser light sources. However, in the context of the present invention, the term “laser light source” is understood to include also the ends of optical waveguides through which laser light is conveyed from remote laser light sources to the specified locations. The same applies analogously to the surgical light source, which itself may be a white light laser source. It is also possible to provide both a conventional white light source (lamp) and a white light laser source, if necessary. This allows the surgeon to select the optimum illumination according to the requirements of each particular application. If a high-power white light laser source is available, this laser source may also be used to provide excitation light or stimulation light by means of prism-based color separation or by filters. If the lasers are pulsed lasers, then the pulse rates and pulse durations may be matched to obtain an optimum emission behavior. The emission behavior may ultimately be captured by the surgeon's eye or by a video chip and further processed, if necessary.

During image processing, the principle of differential signal analysis may be used: Tissue is brought into a known state by conventional illumination with white light. The additional excitation of the tissue with an excitation wavelength is generally not perceived visually, because the excitation light is generally outside the visible spectrum. Illumination of the excited tissue with stimulation light of sufficient quantity results in simultaneous stimulated emission. This means that the illuminated object does not only emit more intensely because of the illumination with stimulation light in this region, but also because of the additionally occurring stimulated emission.

The differential signal between the stimulation and the simultaneous emission in the same wavelength can be readily produced using video techniques, so that the visibility of the stimulated emission can be significantly increased by image processing.

Since the tissues are not “consumed” by the excitation and the stimulated emission, any tissues can be visualized by any number of pulse sequences of excitation light and stimulation light.

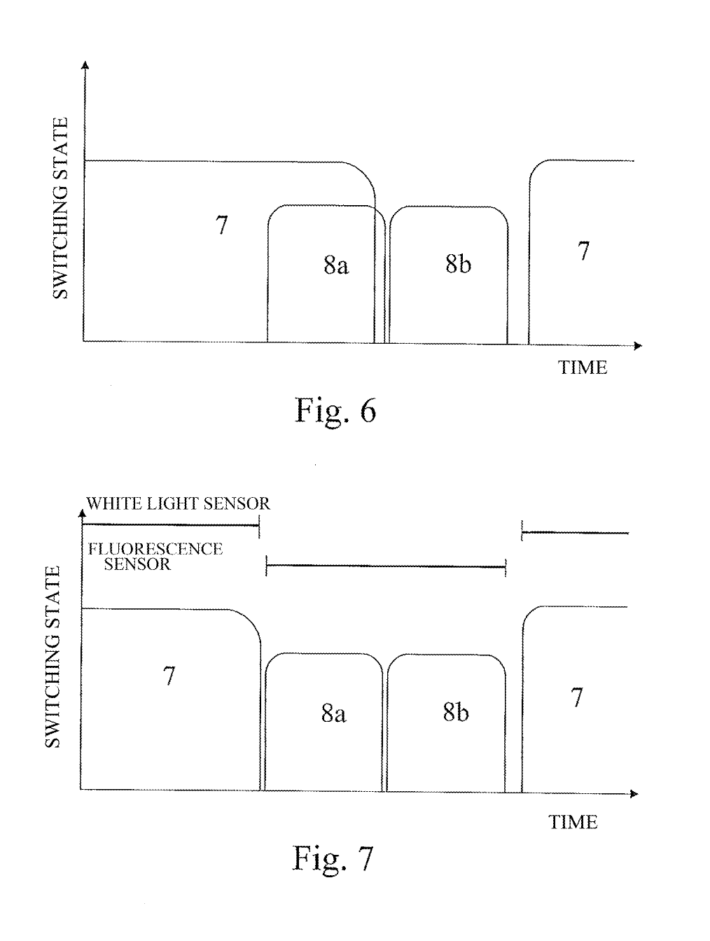

In the following, the operating principle of various modes of operation will be explained in more detail in connection with FIGS. 6, 7, and 8. As a generally known, surgical illumination light source 7 and/or 7a (white light laser) is in principle capable of illuminating the object alone, and enables the surgeon to view and perform surgery at the illuminated spot.

FIG. 6 shows a diagram illustrating a preferred ON/OFF timing of the light sources. The irradiation from surgical illumination light source 7 or 7a (boxed-shaped area designed 7) provides a color-neutral image of object 6 to the surgeon. Excitation light source 8a is turned on while surgical illumination light 7 is still ON. This simultaneous operation increases the excitation efficiency because the white light illumination also contains excitation wavelengths and can therefore contribute to the excitation, but, naturally, only to the extent that it does not contain an equal amount of stimulation wavelengths at the same time. Upon completion of the excitation, the excitation is interrupted and the stimulation is initiated (by turning on stimulation light source 8b). In this embodiment, during the stimulation and the resulting stimulated light emission, surgical illumination light 7 is always OFF or darkened by a shutter, filter, or the like. This prevents the surgical illumination light from swamping the stimulated emission light. The specific ON/OFF timing may be accomplished by the control and data processing unit 16, for example, such that the switching of the excitation light triggers the turn-off of the surgical illumination light in such a way that surgical illumination light 7 is turned off shortly before or at the same time as the excitation light is turned off.

Alternatively (FIG. 7), the surgical illumination light is turned off prior to the excitation. Here, the turning off of surgical illumination light 7 may trigger the turning on of excitation light source 8a.

FIG. 7 also shows symbolically the ON-times of video sensors which are adapted for white light detection on the one hand (white light sensor), and on the other hand serve for fluorescent light detection (detection of the stimulated emission light). Since the recording of the emission light occurs at a different time than the irradiation of white light, there is no overlapping which could cause swamping effects. On the other hand, since light 8a is emitted with a completely different wavelength, mostly a longer wavelength, this at best reflected light can be hidden by image processing.

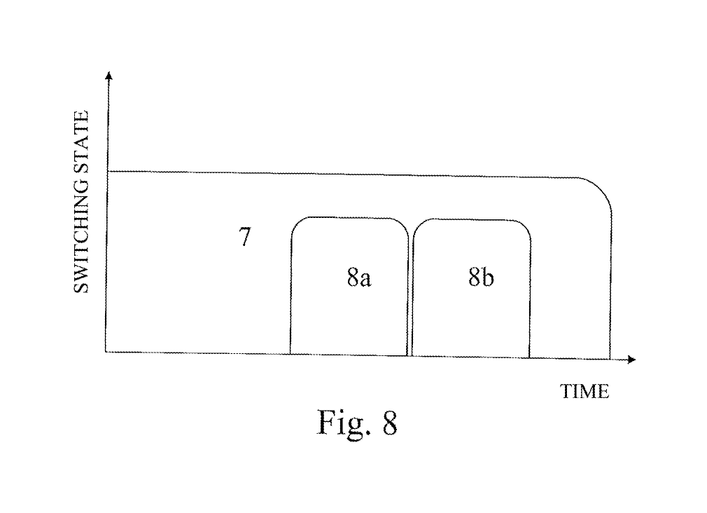

FIG. 8 illustrates another mode of operation, in which surgical illumination light 7 is permanently ON. This is the simplest case in terms of control, but involves the risk of the stimulated emission light being swamped by the surgical illumination light, unless a suitable reduction in light intensity and/or change in light wavelength is performed using suitable filters or screening means. Here, reference is also made to the not previously published German Patent Application DE 10 2010 044 503 of the Applicant.

The selection of individual operating modes may be accomplished by electrical switches. All operating modes that additionally use stimulated emission have in common that the excitation light source and the stimulation light source are switched successively; i.e., a successful stimulation must be preceded by an excitation. Thus, the excitation light source and the stimulation light source are always switched in a time-staggered manner.

FIG. 9 shows a symbolic configuration in which all mentioned laser light sources 7a, 8a, 8b are accommodated in a single unit, while another unit includes the conventional surgical illumination light source 7. Deflecting elements 10c and 10d, here illustrated as prisms, are used to deflect the light and direct it through main objective 2. In the upper portion of the microscope, a beam splitter is provided for extracting light and directing it onto a video chip 19 which is connected to a monitor 20 via a controller 21 with image processing capability.

The present invention is not limited to surgical microscopes, but is applicable to any optical visual aids used in surgery that allow the observer or surgeon to view stimulated emission light. Examples of these include, in particular, endoscopes and other optical visual aids used in surgery, including also surgical loupes. The limitation to stereomicroscopy was chosen deliberately because surgical microscopes are generally stereoscopic microscopes, and because it is precisely this design that provides optimum assistance to the surgeon. In individual cases, however, the present invention may also be suitably used with monoscopic visual aids in a similar way. The claims and the preceding description are to be interpreted in a correspondingly broad sense.

### LIST OF REFERENCE NUMERALS

1 surgical microscope; special-illumination surgical stereomicroscope
2 main objective
3 zoom system
4 tube
5 eyepiece
6 object
7 surgical illumination light source
7a white light laser illumination source; surgical illumination light source
8, 8′ excitation/stimulation device
8a excitation light source
8b stimulation light source
9 input coupling optics
10 deflecting element
10a deflecting element in the form of a scanning mirror
10b scanner motor for scanning mirror
10c deflecting element; deflecting prism
10d deflecting element; deflecting prism
11 illumination beam path
12 excitation/stimulation beam path
12a excitation beam path
12b stimulation beam path
13 excitation/stimulation beam path
14 observation beam path
15 object field
16 control and data processing unit
17 concave mirror
18 laser beam expansion optics
19 image sensor, video chip
20 monitor
21 controller

What is claimed is:

1. A special-illumination surgical stereomicroscope (1) for observing an object (6) in an object field (15) under special illumination, comprising:
a surgical illumination light source (7; 7a) for illuminating the object field (15) via an illumination beam path (11), the surgical illumination light source comprising a special-illumination light source, wherein the special-illumination light source is adapted for observation of stimulated emission and includes:
an excitation light source (8a) for specific excitation of a substance contained in tissue of the object (6) via an excitation beam path (12a),
a stimulation light source (8b) for stimulating the emission of light from the previously excited substance via a stimulation beam path (12b), and
a common observation beam path (14) for guiding the light generated by stimulated emission and surgical illumination light reflected by the object (6).

2. The special-illumination surgical stereomicroscope as recited in claim 1, wherein the excitation light source (8a) and the stimulation light source (8b) are combined into an excitation/stimulation device (8, 8′) as an illumination light source unit, and wherein the excitation beam path (12a) and the stimulation beam path (12b) coincide in an excitation/stimulation beam path (12) from the light sources to the object field (15).

3. The special-illumination surgical stereomicroscope as recited in claim 1, wherein the excitation light source (8a) and the stimulation light source (8b) are combined into an excitation/stimulation device (8′) as an illumination light source unit, and are directed to the object field from a side of the stereomicroscope (1) to illuminate the object field independently of the surgical illumination light source (7, 7a).

4. The special-illumination surgical stereomicroscope (1) as recited in claim 2, wherein the excitation/stimulation device (8, 8′) additionally includes the surgical illumination light source (7, 7a).

5. The special-illumination surgical stereomicroscope (1) as recited in claim 4, wherein the excitation/stimulation device (8, 8′) additionally includes a second surgical illumination light source (7, 7a).

6. The special-illumination surgical stereomicroscope (1) as recited in claim 2, wherein the excitation/stimulation device (8, 8′) constitutes a single illumination light source unit which is replaceably mounted in the surgical microscope (1).

7. The special-illumination surgical stereomicroscope (1) as recited in claim 4, wherein the surgical illumination light source (7), the excitation light source (8a), and the stimulation light source (8b) have a common beam-shaping element associated therewith.

8. The special-illumination surgical stereomicroscope (1) as recited in claim 5, wherein the surgical illumination light source (7), the second illumination light source (7a), the excitation light source (8a), and the stimulation light source (8b) have a common beam-shaping element associated therewith.

9. The special-illumination surgical stereomicroscope (1) as recited in claim 7, wherein the beam-shaping element includes a free-form surface.

10. The special-illumination surgical stereomicroscope (1) as recited in claim 7, wherein the beam-shaping element includes a concave mirror (17).

11. The special-illumination surgical stereomicroscope (1) as recited in claim 10, wherein the surgical illumination light source (7, 7a) is located at the focus of the concave mirror (17), and the excitation light source (8a) and the stimulation light source (8b) are each disposed at a radial distance from surgical illumination light source (7, 7a).

12. The special-illumination surgical stereomicroscope (1) as recited in claim 10, wherein the excitation light source (8a) and the stimulation light source (8b) are disposed in openings formed in a wall of the concave mirror (17).

13. The special-illumination surgical stereomicroscope (1) as recited in claim 1, wherein at least one of the excitation light source (8a), the stimulation light source (8b), and the surgical illumination light source (7, 7a) is a laser light source.

14. The special-illumination surgical stereomicroscope (1) as recited in claim 13, further comprising a second surgical illumination light source (7a), wherein each of the excitation light source (8a), the stimulation light source (8b), and the second surgical illumination light source (7a) is a laser light source.

15. The special-illumination surgical stereomicroscope (1) as recited in claim 1, further comprising a control and data processing unit (16) operable for switching the surgical illumination light source (7, 7a), the excitation light source (8a), and the stimulation light source (8b) in a temporal sequence, the control (16) being adapted to switch the excitation light source (8a) and the stimulation light source (8b) successively.

16. The special-illumination surgical stereomicroscope (1) as recited in claim 15, wherein in an operating state, the control and data processing unit (16) is configured such that during operation of the stimulation light source (8b), the surgical illumination light source (7, 7a) is OFF.

17. The special-illumination surgical stereomicroscope (1) as recited in claim 15, wherein in an operating state, the control and data processing unit (16) is configured such that during operation of the excitation light source (8a), the surgical illumination light source (7, 7a) is ON.

18. The special-illumination surgical stereomicroscope (1) as recited in claim 15, wherein in an operating state, the control and data processing unit (16) is configured such that during operation of the stimulation light source (8b), the surgical illumination light source (7, 7a) is operated at reduced intensity and/or in a spectral region different from the spectral region of the stimulation light source (8b).

19. The special-illumination surgical stereomicroscope (1) as recited in claim 14, wherein the second surgical illumination light source (7a) is a white light laser, and the excitation light source (8a), the stimulation light source (8b), and the second surgical illumination light source (7a) are interconnected with at least two image sensors in a clocked manner, one of the image sensors being provided for processing the white light and the other image sensor being provided for processing the stimulated emission light.

20. The special-illumination surgical stereomicroscope (1) as recited in claim 14, wherein at least one of the excitation light source (8a), the stimulation light source (8b), and the second surgical illumination light source (7a) has a scanning device associated therewith for directing the emitted laser light onto the object (6).

21. A method for operating a special-illumination surgical stereomicroscope (1) according to claim 1, comprising the step of successively switching between the excitation light source (8a) and the stimulation light source (8b) at a predefined pulse frequency.

22. The method as recited in claim 21, wherein the surgical illumination light source (7, 7a) is OFF, or is operated at reduced intensity and/or in a spectral region different from that of the stimulation light source (8b), during operation of the stimulation light source (8b).

23. The method as recited in claim 21, wherein the surgical illumination light source (7, 7a) is ON during operation of the excitation light source (8a).
